(19) United States
(12) Patent Application Publication
(10) Pub. No.: US 2008/0069358 A1
(43) Pub. Date: Mar. 20, 2008

(54) PORTABLE STORAGE DEVICE WITH WIRELESS ENCRYPTION PROTECTION

(75) Inventor: Cheng-chih Yang, Taipei City (TW)

Correspondence Address: MADSON & AUSTIN, 15 WEST SOUTH TEMPLE, SUITE 900, SALT LAKE CITY, UT, 84101, US

(73) Assignee: Genesys Logic, Inc., Shindian City (TW)

(21) Appl. No.: 11/854,718

(22) Filed: Sep. 13, 2007

(30) Foreign Application Priority Data
Sep. 18, 2006 (TW) 095216588

(51) Int. Cl. H04L 9/32

(52) U.S. Cl. 380/247

(57) ABSTRACT

A portable storage device with wireless encryption protection is provided, including wireless identification remote control, for transmitting identification signal and information or lock control signal through wireless transmission, a memory interface connected to a data access host, for inputting decryption information from the data access host and for outputting to data access host, a wireless protection gate unit connected to the memory interface for receiving the identification signal and information or lock control signal issued by the wireless identification remote control, and enabling or disabling the data transmission to the memory interface according to the identification result, and at least a protected data region connected to the wireless protection gate unit, for the protected data region to output data to data access host when the wireless protection gate unit being enabled, so that the portable storage device can achieve the objects of accurate and permanently effective wireless encryption.

### BACKGROUND OF THE INVENTION

1. Field of the Invention

The present invention relates to a portable storage device with wireless encryption protection and, more particularly, to a portable storage device with wireless encryption and identification to protect unauthorized access.

2. The Related Arts

Flash memory is widely used in many types of digital equipment, such as flash memory sticks, and MP3 players. However, conventional flash memory sticks and MP3 players do not provide any data security protection so that the data stored in the flash memory in these devices are prone to exposure to authorized access. For example, if the flash memory sticks and MP3 players are stolen or misplaced, the data may be subjected to public access, which may lead to further financial or privacy damage.

Taiwan Patent Publication No. 200604958 disclosed a flash memory stick with encryption device, which uses encryption pairing or encryption key to provide encryption protection. However, this type of memory stick is constrained by the use of instant messaging or similar platform on Internet. This approach does not provide stand-alone encryption operation and protection.

Taiwan Patent Publication No. M288421 disclosed a portable storage device with highly encrypted security, which includes the use of bio-feature identification, such as fingerprint identification. Although the disclosed device is provided with bio-feature identification to protect against unauthorized access, there are several disadvantages, including the need of a portable bio-feature sensor and a microprocessor to process the identification, resulting in the cost of the portable storage device. In addition, the bio-feature sensor is usually on the outer surface of the portable storage device for collecting bio-features, and thus may accumulate dust or other contamination to cause misidentification of the bio-features. All these lead to loss of data permanently.

### SUMMARY OF THE INVENTION

An object of the present invention is to provide a portable storage device with encryption protection for providing data access hosts and storage device with accurate and effective mechanism.

Another object of the present invention is to provide a portable storage device with encryption protection, including the use of wireless remote control in encryption and identification so as to eliminating the use of password or complicated decryption operation.

Yet another object of the present invention is to provide a portable storage device with encryption protection without the use of expensive bio-feature identification sensor and microprocessor, so as to reduce the manufacturing cost and prolong the encryption effectiveness life span.

To achieve the above objects, the present invention provides a portable storage device with wireless encryption protection, comprising wireless identification remote control for transmitting identification signal and information or a lock control signal through wireless transmission, a memory interface connected to a data access host for inputting decryption information from the data access host and for outputting to data access host, a wireless protection gate unit connected to the memory interface for receiving the identification signal and information or lock control signal issued by the wireless identification remote control, and enabling or disabling the data transmission to the memory interface according to the identification result, and at least a protected data region connected to the wireless protection gate unit for the protected data region to output data to a data access host when the wireless protection gate unit is enabled, so that the portable storage device can achieve the objects of accurate and permanently effective wireless encryption.

These and other objects, features, and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention will be apparent to those skilled in the art by reading the following description of Preferred embodiments thereof with reference to the attached drawings, wherein:

FIG. 1 shows a portable storage device with wireless encryption protection constructed in accordance with a first embodiment of the present invention;

FIG. 2 shows a portable storage device with wireless encryption protection constructed in accordance with a second embodiment of the present invention;

FIG. 3 shows a portable storage device with wireless encryption protection constructed in accordance with a third embodiment of the present invention; and

FIG. 4 shows an application of the portable storage device with wireless encryption protection in accordance with the present invention.

### DETAILED DESCRIPTION OF THE PREFERRED EMBODIMENTS OF THE PRESENT INVENTION

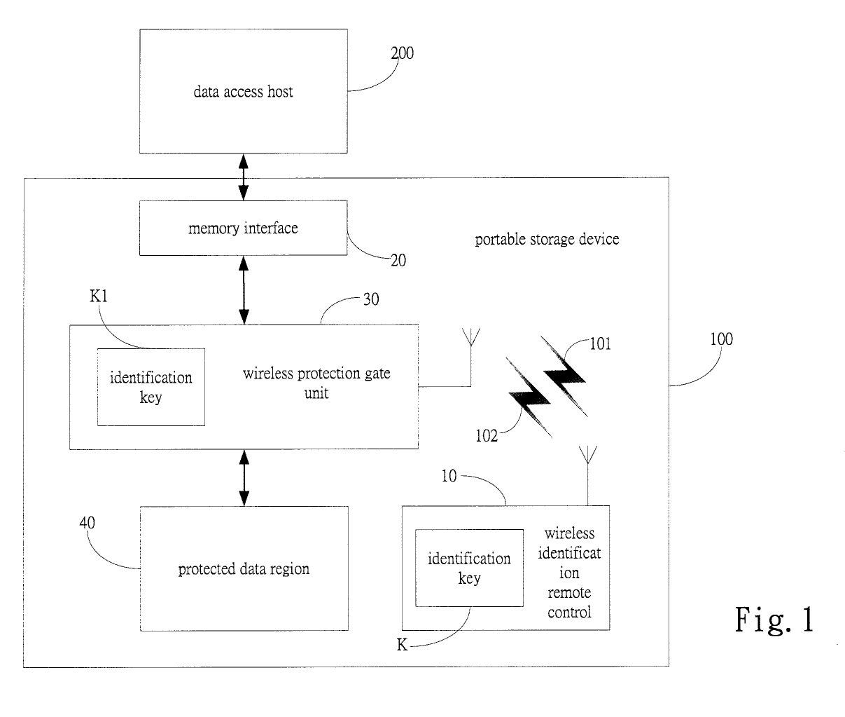

With reference to the drawings and in particular to FIG. 1, which shows a portable storage device with wireless encryption protection constructed in accordance with a first embodiment of the present invention, generally designated with reference numeral 100, the portable storage device 100 comprises a wireless identification remote control 10, a memory interface 20, a wireless protection gate unit 30, and at least a protected data region 40. The wireless identification remote control 10 transmits wirelessly an identification signal and information 101 or a lock control signal 102. The wireless identification remote control 10 stores at least an identification key K. The wireless identification remote control 10 is not limited to any specific type. The portable storage device of the first embodiment uses an RF wireless remote control as an example. Other equivalent types of IR wireless remote control devices or wireless signal transmitters are all within the scope of the present invention.

The memory interface 20 is connected to an interface port 210 of a data access host 200. The m interface 20 is not limited to any specific type. The present embodiment uses a USB interface as an example. Other equivalent types of interface are also within the scope of the present invention. The data access host 200 is not limited to any specific type. The present embodiment uses a PC as an example, and the interface port 210 is a USB interface port. Other equivalent types of data access hosts, such as game machine, notebook PC or devices with USB interface, are also within the scope of the present invention. The data access host 200 inputs data through the memory interface 20 to the portable storage device 100, and the portable storage device 100 outputs stored data through the memory interface 20 to the data access host 200.

The wireless protection gate unit 30 is connected to the memory interface 20. The wireless protection gate unit 40 receives wirelessly identification signal and information 101 or lock control signal 102 from the wireless identification remote control 10. The wireless protection gate unit 30 pre-stores an identification key K1, and enables or disables the data transmission to the memory interface 20 after identifying the identification signal and information 101 or lock control signal 102. If the identification signal and information 101 passes the identification process and is confirmed, the wireless protection gate unit 30 enables the data communication with the memory interface 20. If the wireless protection gate unit 30 receives the lock control signal 102 from the wireless identification remote control 10, the wireless protection gate unit 30 disables the data communication with memory interface; thus, the wireless protection gate unit 30 is disconnected from the memory interface 20.

The protected data region 40 is connected to and controlled by the wireless protection gate unit 30. When the identification is confirmed, the wireless protection gate unit 30 is enabled, and the data stored in the protected data region 40 can be outputted through the wireless protection gate unit 30, the memory interface 20 to the data access host 200.

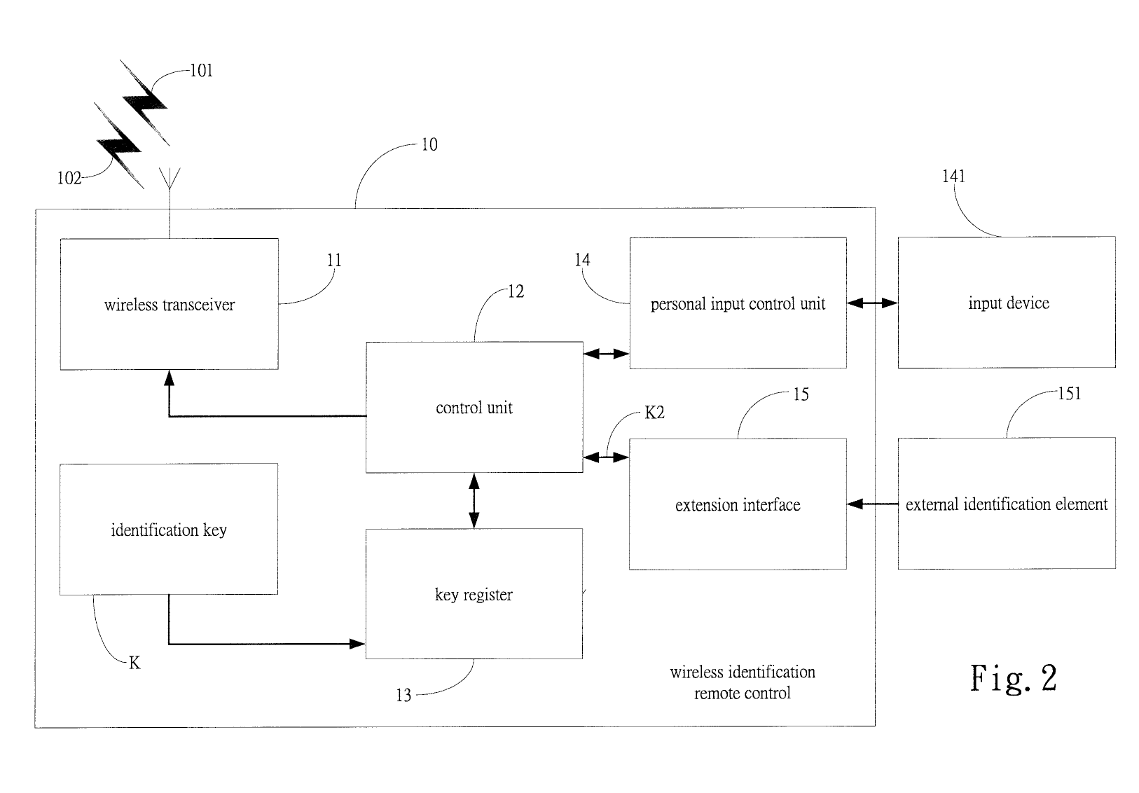

FIG. 2 shows a portable storage device 100 with wireless encryption protection in accordance with a second embodiment of the present invention, where the wireless identification remote control 10 comprises a wireless transceiver 11, a control unit 12, a key register 13, a personal input control unit 14 and at least an extension interface 15. The wireless transceiver 11 is for transmitting an identification signal and information 101 or a lock control signal 102. The control unit 12 is connected to the wireless transceiver 11 for converting an identification key K into a corresponding identification signal and information for the wireless transceiver 11 to transmit, and for controlling the wireless transceiver 11 to transmit the lock control signal 102.

The key register 13 is for storing the identification key K. The identification key K is not limited to a specific password or value. The identification key K may include a plurality of passwords, values or PWM mode signals and machine code data.

The personal input control unit 14 is connected to the control unit 12 and an input device 141. The input device 141 is not limited to any specific type. The present embodiment uses a keyboard as an example for the user to enter the decryption or lock commands to the control unit 12. The control unit 12, based on the entered commands, controls the wireless transceiver 11 to transmit the identification signal and information 101 or the lock control signal 102.

The extension interface 15 is connected to the control unit 12 and at least an external identification element 151. The extension interface 15 is not limited any specific type, and the present embodiment uses a flash memory interface as an example. The external identification element 151 is not limited to any specific type, and the present embodiment uses a flash memory card as an example. Through the external identification element 151 providing an identification key K2 to the control unit 12, the control unit 12 can choose, based on the decryption command from the input device 141 of the personal input control unit 14, the key K in the key register 13, the key K2 from the external identification element 151, or any logical computation with the above two keys to determine the identification signal and information 101 issued by the wireless transceiver 11.

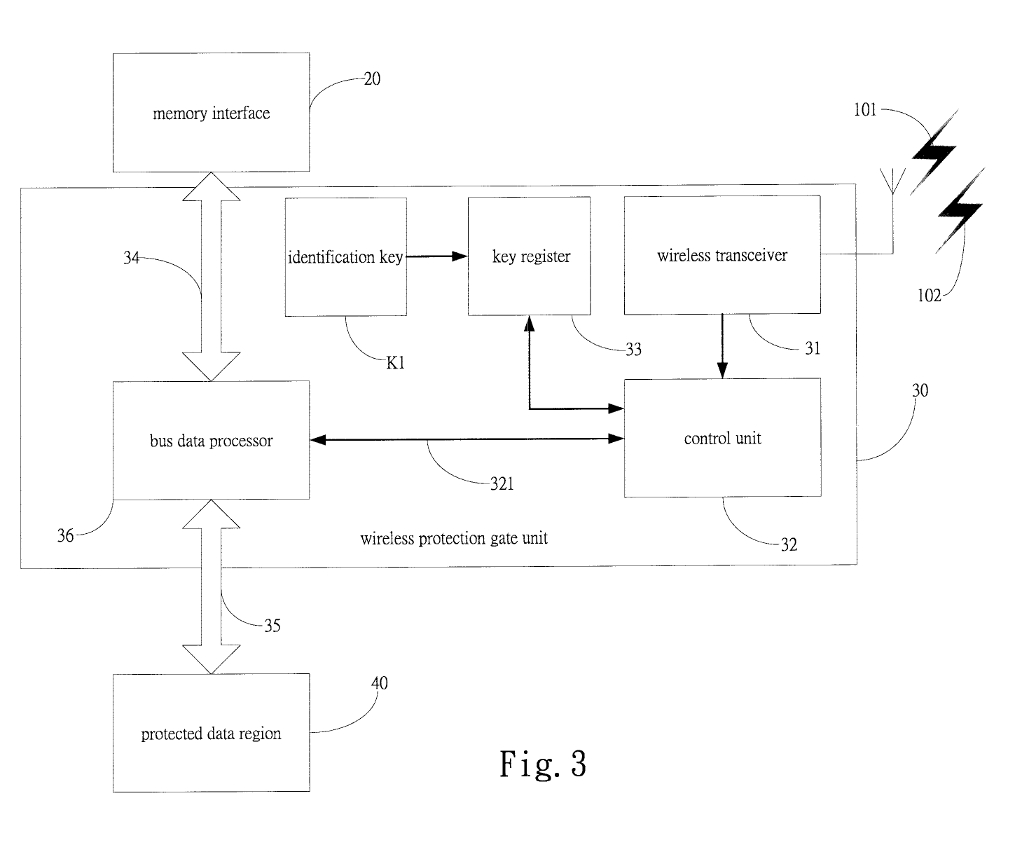

FIG. 3 shows a portable storage 100 constructed in accordance with a third embodiment of the present invention, where the wireless protection gate unit 30 comprises a wireless transceiver 31, a control unit 32, a key register 33, at least an upstream bus 34, a downstream bus 35, and a bus data processor 36. The wireless transceiver 31 is for receiving the identification signal and information 101 and the lock control signal 102. The control unit 32 is connected to the wireless transceiver 31 for identifying the received identification signal and information 101 and lock control signal 102 and determining a control signal 321 to control the enabling and disabling of the data transmission.

The key register 33 is connected to the control unit 32, and is for storing the key K1 so as to provide the basis for encryption identification of the identification signal and information 101 of the wireless identification remote control 10.

The upstream bus 34 is connected to the memory interface 20, and the downstream bus 35 is connected to the protected data region 40. The bus data processor 36 is connected to the upstream bus 34, the downstream bus 35, and the control unit 32. The bus data processor 36 determines, based on the control signal 321 from the control unit 32, whether the upstream bus 34 and the downstream 35 should be connected to disconnected; thus, the connection or disconnection between the protected data region 40, and the memory interface 20 and the data access host 200. This achieves the object of wireless decryption and lock protection.

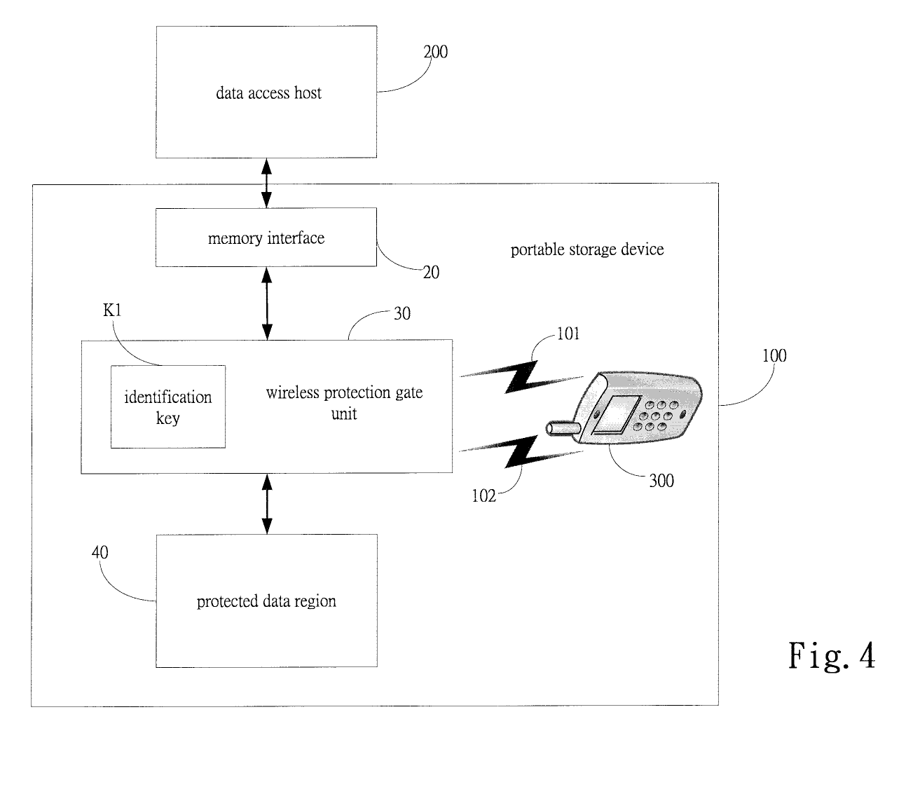

FIG. 4 shows an application of the portable storage device 100 of the present invention. The wireless identification remote control 10 is connected to an IrDA cellular phone 300. Through the IR wireless transmission of IrDa cellular phone 300 to perform decryption or locking, the present invention can be used to access the protected data region 40.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A portable storage device with wireless encryption protection, comprising:
a wireless identification remote control for transmitting wirelessly an identification signal and information, or a lock control signal, and storing an identification key;
a memory interface connected to an interface port of a data access host for inputting data from the data access host and for outputting data to the data access host;
a wireless protection gate unit connected to the memory interface for receiving wirelessly the identification signal and information, or the lock control signal, storing an identification key, and enabling or disabling the data transmission to the data access host through the memory interface according to the identification signal and information, or the lock control signal; and
at least a protected data region connected to and controlled by the wireless protection gate unit for the protected data region through the protection gate unit and the memory interface to output data to the data access host when the wireless protection gate unit is enabled after identification confirmation of the identification signal and information, or disconnecting data transmission when the wireless protection gate unit is disabled by the lock control signal.

2. The portable storage device as claimed in claim 1, wherein the wireless identification remote control is integrated with an IrDA cellular phone.

3. The portable storage device as claimed in claim 1, wherein the wireless identification remote control comprises:
a wireless transceiver for transmitting the identification signal and information or the lock control signal;
a control unit connected to the wireless transceiver for converting the identification key into the identification signal and information or the lock control signal for the wireless transceiver to transmit;
a key register for storing the identification key;
a personal input control unit connected to the control unit for inputting decryption and lock commands to the control unit so that the control unit controls the wireless transceiver to transmit the identification signal and information or the lock control signal according to the decryption or lock command; and
an extension interface connected to the control unit an at least an external identification element, for the external identification element to provide another identification key to the control unit.

4. The portable storage device as claimed in claim 3, wherein the personal input control device is connected to an input device.

5. The portable storage device as claimed in claim 4, wherein the input device is a keyboard.

6. The portable storage device as claimed in claim 3, wherein the extension interface is a flash memory interface.

7. The portable storage device as claimed in claim 3, wherein the external identification element is a flash memory card.

8. The portable storage device as claimed in claim 1, wherein the memory interface is a USB interface.

9. The portable storage device as claimed in claim 1, wherein the wireless protection gate unit comprises:
a wireless transceiver for receiving the identification signal and information or the lock control signal from the wireless identification remote control;
a control unit connected to the wireless transceiver for identifying the identification signal and information or said lock control signal to determine the issuing of a control signal of enabling or disabling;
a key register connected to the control unit for providing an identification key to the control unit to identify the identification signal and information from the wireless identification remote control;
at least an upstream bus connected to the memory interface;
at least a downstream bus connected to the protected data region; and
at least a bus data processor connected to the upstream bus, the downstream bus, and the control unit, based on the control signal of enabling or disabling to determine whether the upstream bus and the downstream bus is connected, hence controlling the connection and disconnection between the protected data region, and the memory interface and the data access host.
